(19) United States
(12) Patent Application Publication
(10) Pub. No.: US 2018/0338067 A1
(43) Pub. Date: Nov. 22, 2018

(54) COLOR VALUE CORRECTION CONTROL METHOD, COLOR VALUE CORRECTION CONTROL PROGRAM, AND IMAGE FORMING APPARATUS

(71) Applicant: KONICA MINOLTA, INC., Tokyo (JP)

(72) Inventor: Tomoko Kuroiwa, Tokyo (JP)

(73) Assignee: KONICA MINOLTA, INC., Tokyo (JP)

(21) Appl. No.: 15/967,756

(22) Filed: May 1, 2018

(30) Foreign Application Priority Data
May 18, 2017 (JP) 2017-098624

(51) Int. Cl. H04N 1/60

(52) U.S. Cl. CPC H04N 1/6008; H04N 1/6075; H04N 1/6019; H04N 1/6041

(57) ABSTRACT

Provided is a color value correction control method that uses a printing system including: a printer that prints a chart; a scanner that measures the chart to acquire an RGB value; and a colorimeter that measures the chart to acquire a color value, the method including: generating data of the chart; estimating a color value using the RGB value obtained by the scanner measuring the chart; and calculating a correction amount of the color value, wherein in the generating, a first patch group and a second patch group are provided and data of a chart including a specific patch with the same CYMK value as a CYMK value of each patch of the second patch group in the first patch group is generated, in the estimating, the color value is estimated using an RGB value, and in the calculating, the correction amount of the color value is calculated.

The entire disclosure of Japanese patent Application No. 2017-098624, filed on May 18, 2017, is incorporated herein by reference in its entirety.

### BACKGROUND

### Technological Field

The present invention relates to a color value correction control method, a color value correction control program, and an image forming apparatus and, in particular, to a color value correction control method, a color value correction control program, and an image forming apparatus including a colorimeter that measures a color value, which calculate a correction amount for correcting a color value in consideration of a flare level.

### Description of the Related Art

Color verification work is performed to confirm how much colors specified by a variety of color certification standards can be reproduced by an image forming apparatus. This color verification is performed by using a spectrocolorimeter to colorimetrically measure a color evaluation chart output and printed after color conversion is applied using a color management system (CMS) and comparing a color value obtained by the colorimetry with a color value specified by a color certification standard. The above-mentioned spectrocolorimeter measures light reflected on a printing medium for each wavelength by applying light from a light source to the printing medium and integrates the measurement result with a color matching function adapted to the characteristics of human eyes to acquire color values (L*a*b* values, XYZ values, and the like) in a uniform color space. Thus, colorimetry of the color evaluation chart takes time.

Meanwhile, there is a technique of estimating colors in the uniform color space using a scanner and the scanner profile. In this technique, since the measurement of RGB values can be performed at high speed using the scanner, the time can be shortened as compared with the technique of colorimetry using the spectrocolorimeter. In addition, as a technique for improving the accuracy of color values estimated using the scanner profile, there is a technique of preparing the scanner profile for each K plate (black) amount. In this technique, it is possible to estimate a color value with higher accuracy by performing color estimation from the acquired RGB values and the K plate amount of the color evaluation chart using the scanner profile for each K plate amount.

Here, when RGB values are acquired by measuring the color evaluation chart with a scanner, it is necessary to selectively measure reflected light from an object patch to be measured. However, in reality, in addition to the reflected light from the object patch to be measured, output blended with reflected light from neighboring patches due to irregular reflection is measured. Such a phenomenon in which reflected light over the original output is measured due to irregular reflection between an object to be measured and a light source is called flare and the influence of the flare needs to be corrected when the RGB values are acquired.

Regarding a technology for correcting this influence of the flare, for example, JP 2003-283773 A discloses a flare correction data gauging method for an image reading apparatus including: an illumination means that irradiates a reading surface of an original copy placed on an original copy placing surface with light; and an image pickup means that picks up an image of the reading surface of the original copy by light radiated on the reading surface, the image reading apparatus generating image signal data from a signal output from the image pickup means, in which a point light source is provided on a gauging original copy whose reading surface is formed by a diffuse reflecting surface, an image of light reflected from the entire surface of the reading surface by light emitted from the point light source is picked up by the image pickup means, image signal intensity distribution data is generated from a signal output from the image pickup means by dividing the picked-up image into image areas with a light-emitting image area of the point light source as a basic unit, and flare correction data is calculated from the generated image signal intensity distribution data and illuminance distribution data of the reading surface detected in advance by causing the illumination means to emit light.

Regarding a technology for creating a chart with less influence of flare, for example, JP 2016-159540 A discloses a chart creating method for a system including: an image forming apparatus provided with a printer and a colorimeter; and a control apparatus that controls the image forming apparatus, the chart creating method executing: a first chart creating process in which the control apparatus generates a print image of a chart on which a plurality of patches is arranged and instructs the image forming apparatus to print and colorimetrically measure the chart, and the image forming apparatus prints the chart and colorimetrically measures each patch on the chart; a rearrangement process in which the control apparatus acquires a colorimetric value of each patch on the chart from the image forming apparatus and rearranges the patches such that, in the chart, variations in average colorimetric values each obtained by averaging the colorimetric values of respective patches in a small patch group made up of an object patch to be colorimetrically measured and neighboring patches of the object patch fall within a predetermined range; and a second chart creating process in which the control apparatus generates a print image of the chart on which the patches are rearranged and instructs the image forming apparatus to print and colorimetrically measure the chart, and the image forming apparatus prints the chart on which the patches are rearranged and colorimetrically measures each patch on the chart.

In JP 2003-283773 A, the flare correction data is previously prepared and a pixel value of interest is corrected focusing attention on a total value with neighboring pixel values, whereby image data without the influence of flare is generated. However, this technique requires previously defining flare amounts for all charts and thus it is difficult to dynamically correct the color values of a variety of charts.

Meanwhile, in JP 2016-159540 A, in order to improve the estimation accuracy of the scanner profile, patches that are not subject to colorimetry (disposable patches) are arranged in a chart utilizing the scanner profile such that flare levels of a scanner profile creating chart and a scanner profile utilizing chart are equalized. However, since this technique determines the arrangement of the patches on the premise that patch sizes are identical to each other, the influence of flare due to a size difference remains for a chart in which patches of a plurality of sizes are mixed.

### SUMMARY

The present invention has been made in view of the above problems, and a main object thereof is to provide a color value correction control method, a color value correction control program, and an image forming apparatus, which can simply and properly calculate a correction amount for correcting a color value in consideration of a flare level for a chart in which patches of different sizes are mixed.

To achieve the abovementioned object, according to an aspect of the present invention, there is provided a color value correction control method that uses a printing system including: a printer that prints a chart on a printing medium; a scanner that measures the chart to acquire an RGB value; and a colorimeter that measures the chart to acquire a color value made up of an L*a*b* value or an XYZ value, and the method reflecting one aspect of the present invention comprises: generating data of the chart; estimating a color value using the RGB value obtained by the scanner measuring the chart printed by the printer based on the data and a scanner profile stored in advance; and calculating a correction amount of the color value based on the color value obtained by the colorimeter measuring the chart and the estimated color value, wherein in the generating, a first patch group for acquiring an RGB value used for color evaluation made up of a plurality of patches of a first size and a second patch group made up of a plurality of patches of a second size larger than the first size are provided and data of a chart including a specific patch with the same CYMK value as a CYMK value of each patch of the second patch group in the first patch group is generated, in the estimating, the color value is estimated using an RGB value obtained by measuring the specific patch in the first patch group and the scanner profile, and in the calculating, the correction amount of the color value is calculated based on a color value obtained by measuring each patch of the second patch group and the estimated color value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating a configuration of a printing system according to an embodiment of the present invention;

FIG. 2 is a schematic diagram illustrating another configuration of the printing system according to the embodiment of the present invention;

FIGS. 3A and 3B are block diagrams illustrating a configuration of a client apparatus according to an embodiment of the present invention;

FIG. 4 is an external view of an image forming apparatus according to an embodiment of the present invention;

FIGS. 5A and 5B are block diagrams illustrating a configuration of an image forming apparatus according to an embodiment of the present invention;

FIG. 6 is a block diagram illustrating data stored in a storage of an image forming apparatus according to an embodiment of the present invention;

FIG. 7 is a flowchart diagram illustrating an action (chart generation) of an image forming apparatus according to an embodiment of the present invention;

FIG. 8 is a flowchart diagram illustrating an action (color verification) of an image forming apparatus according to an embodiment of the present invention;

FIG. 9 is a flowchart diagram illustrating an action (correction control) of an image forming apparatus according to an embodiment of the present invention;

FIG. 10 is a flowchart diagram illustrating an action (history management) of an image forming apparatus according to an embodiment of the present invention;

FIGS. 11A and 11B are examples of an image of a color verification chart (only evaluation patches) according to an embodiment of the present invention;

FIG. 12 is an example of a color verification chart according to an embodiment of the present invention;

FIG. 13 is a table illustrating an example of the color verification;

FIG. 14 is a diagram for explaining hybrid correction;

FIG. 15 is a diagram illustrating color distributions of the color evaluation chart and a scanner profile in the case of K=0;

FIG. 16 is an example of a chart used for hybrid colorimetry;

FIG. 17 is a diagram for explaining the influence of flare due to a patch arrangement;

FIG. 18 is a diagram for explaining the influence of flare due to patch size;

FIG. 19 is a diagram for explaining the hybrid correction when there is an evaluation patch with the same CMYK values as those of a colorimetric patch (white patch); and

FIG. 20 is a diagram for explaining the hybrid correction when there is no evaluation patch with the same CMYK values as those of a colorimetric patch (cyan 100% patch).

### DETAILED DESCRIPTION OF EMBODIMENTS

Hereinafter, one or more embodiments of the present invention will be described with reference to the drawings. However, the scope of the invention is not limited to the disclosed embodiments.

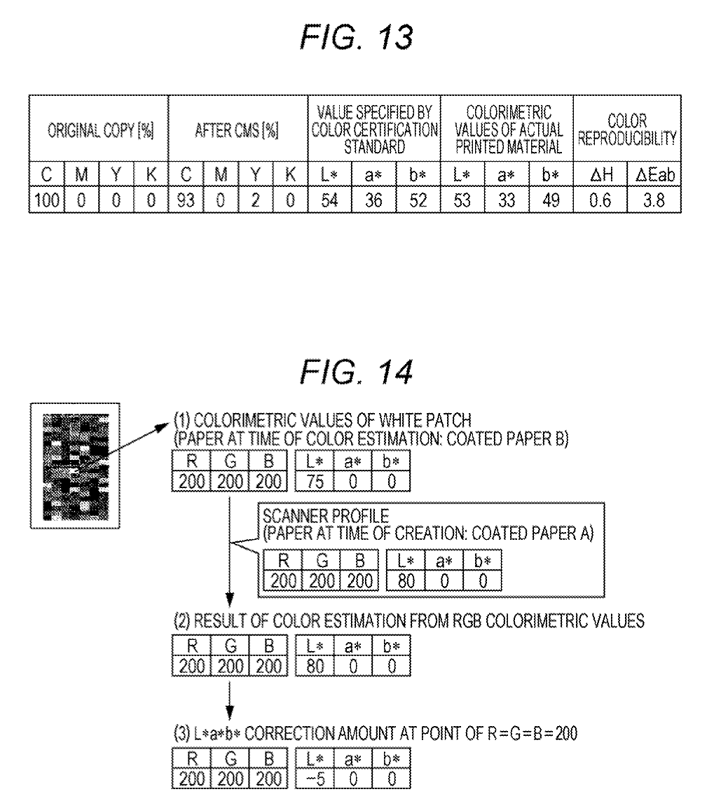

As indicated in the related art, an image forming apparatus performs color verification by causing a spectrocolorimeter to colorimetrically measure a color evaluation chart output and printed after color conversion is applied using a CMS and comparing a color value obtained by the colorimetry with a color value specified by a color certification standard. For example, in the Japan Color certification, it is required that a hue difference ΔH of cyan solid is within four and a color difference ΔE thereof is within six. FIG. 13 illustrates an example of a result of color verification relating to the cyan solid and the result satisfies the color verification criteria since ΔH is 0.6 and ΔE (ΔEab in FIG. 13) is 3.8. Note that the color verification has multiple verification items besides the cyan solid.

Here, the spectrocolorimeter measures light reflected on a printing medium for each wavelength by applying light from a light source to the printing medium and integrates the measurement result with a color matching function adapted to the characteristics of human eyes to acquire color values (L*a*b* values, XYZ values, and the like) in a uniform color space. This spectrocolorimeter includes a handy type spectrocolorimeter and an automatic paper feeding type spectrocolorimeter but, in both types, it takes time to colorimetrically measure the color evaluation chart. Meanwhile, there is also a technique of estimating a color in the uniform color space using a scanner and a scanner profile. In this technique, although an RGB values can be measured at high speed by the scanner, even the same RGB value has multiple correspondences to the color value in the uniform color space and thus it cannot be said that the accuracy of the color value estimated using the scanner profile is high. As a technique for easily solving this problem, there is a technique of preparing the scanner profile for each K plate (black) amount. In this technique, it is possible to estimate the color value with higher accuracy by estimating a color from acquired RGB values and the K plate amount of the color evaluation chart using the scanner profile for each K plate amount.

Incidentally, in order to create the scanner profile for each K plate amount, it is necessary that a chart for creating the scanner profile is printed, the chart is measured with a scanner to acquire the RGB values, while the chart is colorimetrically measured by a spectrocolorimeter to acquire L*a*b* values, and then, after being associated with the K value of the chart for creating the scanner profile, a correspondence table between the RGB values and the L*a*b* values is constructed for each K plate amount. Besides, in a case where a sheet used when the scanner profile is created using this procedure is different from a sheet on which a color evaluation chart for performing color evaluation using this scanner profile is to be printed, color estimation accuracy is lowered even if the scanners have the same lot. That is, in order to enhance the color estimation accuracy, the scanner profile needs to be created for each sheet and each scanner using the above procedure and it is troublesome to create such a large number of scanner profiles.

In response to this problem, the applicant of the present application has proposed correction using a scanner and a spectrocolorimeter in combination (hereinafter referred to as hybrid correction) in the prior application (Japanese Patent Application No. 2015-217381). In this hybrid correction, as illustrated in FIG. 14, a predetermined patch in the color evaluation chart is measured by both the spectrocolorimeter and the scanner such that both the L*a*b* values and the RGB values are acquired. Then, the L*a*b* values are estimated using the acquired RGB values and the scanner profile to work out an L*a*b* correction amount from the L*a*b* values that have been estimated (referred to as estimated L*a*b* values) and the L*a*b* values obtained by colorimetry with the spectrocolorimeter (referred to as the colorimetric L*a*b* values).

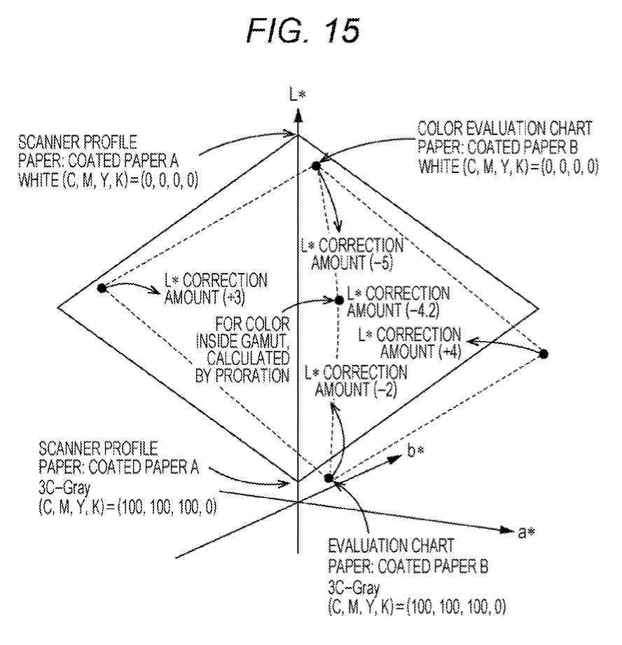

The hybrid correction uses a plurality of patches and, as illustrated in FIG. 15, these patches have CMYK values mostly forming color gamut shell colors (black circle points in FIG. 15). There are also a plurality of L*a*b* correction amounts worked out from the plurality of patches. In a case where the color of a certain patch on the color evaluation chart is a color inside the color gamut, the L*a*b* correction amount can be calculated by prorating this plurality of L*a*b* correction amounts. Then, the calculated L*a*b* correction amount is applied to all patches on the printed color evaluation chart used for evaluation, whereby it is possible to correct the estimated L*a*b* values and obtain the estimated L*a*b* values that have been corrected (referred to as corrected L*a*b* values). By performing such hybrid correction, the corrected L*a*b* values with higher accuracy can be calculated without previously preparing the scanner profiles for each sheet and each scanner.

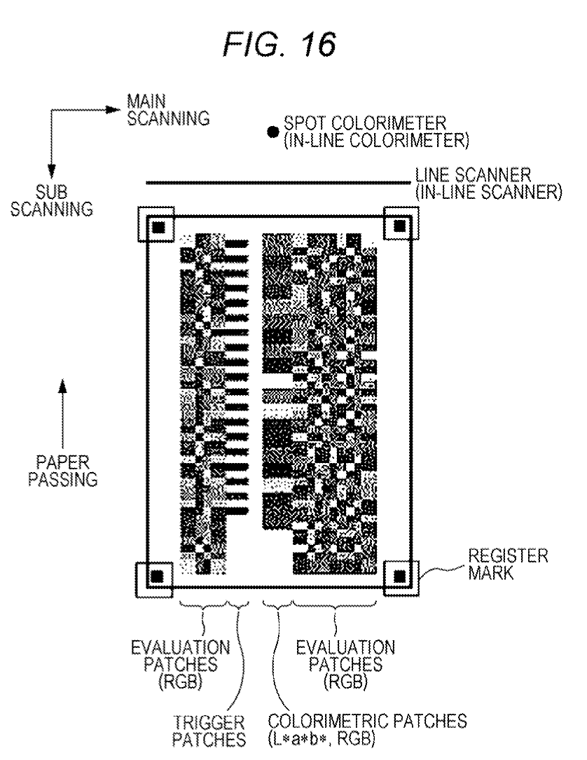

In order to simply perform the above-described hybrid correction, it is preferable to arrange an in-line scanner and an in-line colorimeter on a conveyance path inside the image forming apparatus, through which the printed chart is conveyed to a paper discharge tray. In such an image forming apparatus, a chart with a layout as illustrated in FIG. 16 is used and, for example, the chart passes through a line scanner (in-line scanner) with a resolution of 1×1 unit and a spot colorimeter (in-line colorimeter) with a resolution of 2×4 units, which stand by in a paper passing direction, such that the RGB values and the L*a*b* values can be acquired. The spot colorimeter colorimetrically measures the L*a*b* values with a trigger patch as a starting point. In order to perform spot colorimetry, it is necessary to make a paper passing speed slower and also to make a patch size larger. Meanwhile, the line scanner finds the position of the patch from the paper passing speed with a register mark as a marker and averages the RGB values at a center portion of each patch to measure.

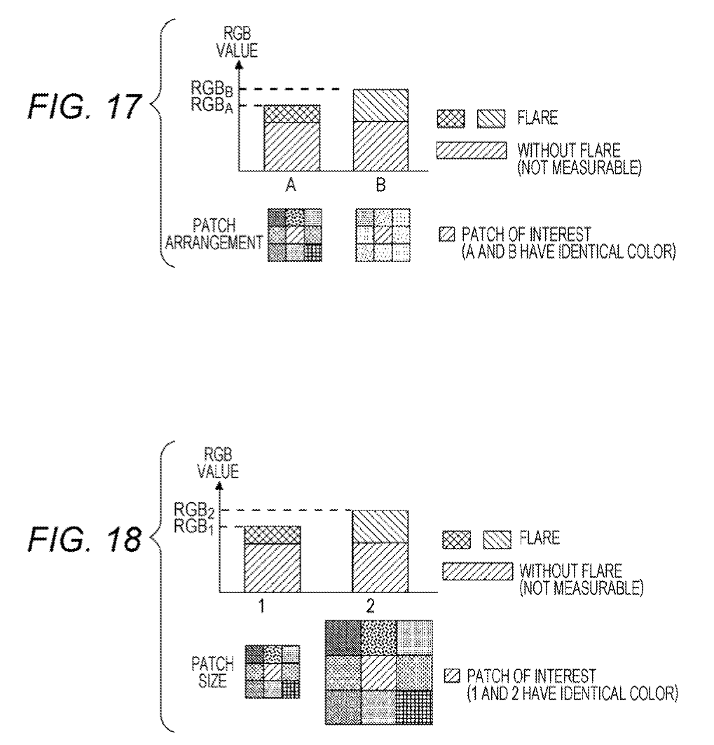

Here, flare will be explained with reference to FIGS. 17 and 18. Flare is a phenomenon in which reflected light over the original output is obtained due to irregular reflection between an original copy and a light source. If the patch color around a patch of interest and the size of the patch of interest are changed, the influence amount of the flare varies. For example, as illustrated in FIG. 17, if patches around the patch of interest are bright (FIG. 17 expresses the light and darkness of the patches by shading of hatching), the acquired RGB value involving the flare becomes large (RGB_{B}>RGB_{A}). In addition, as illustrated in FIG. 18, if the patch of interest is a bright patch and the size thereof is larger, the acquired RGB value involving the flare becomes large (RGB₂>RGB₁). Furthermore, when the patch of interest is dark, the acquired RGB value is less affected by the flare.

Regarding this flare, JP 2003-283773 A proposes a technique of previously preparing flare correction data to generate image data without the influence of the flare by correcting a pixel value of interest focusing attention on a total value with neighboring pixel values. In this technique, however, it is necessary to previously define flare amounts for all charts and thus it is difficult to dynamically correct the color values of a variety of charts.

In addition, JP 2016-159540 A proposes a technique for working out an order in which the variance of an average RGB value group for each small group is minimized through round-robin shuffling so as to make the flare influence received from the surroundings of each patch the same. However, since this technique determines the patch order on the premise that the patch sizes are identical to each other, it is difficult to equalize the influence of the flare when patches of different sizes are mixed. In particular, the chart for performing the hybrid correction has a configuration as illustrated in FIG. 16, where the size of a patch (referred to as colorimetric patch) arranged at a position to be colorimetrically measured by the spot colorimeter (in-line colorimeter) and the size of a patch (referred to as evaluation patch) to be measured only by the line scanner (in-line scanner) are different. Thus, the influence of the flare on each patch cannot be equalized even if the technology of JP 2016-159540 A is used.

In order to equalize the influence of the flare, it is possible to create the evaluation patch with the patch size of the colorimetric patch. However, if the evaluation patch is created with the patch size of the colorimetric patch, the number of charts will grow, causing wasteful consumption of resources. Moreover, the measurement time of the charts increases and the convenience of a user remarkably deteriorates. Accordingly, this technique cannot be adopted.

Such a background requires a proposal of a technique capable of properly correcting the influence of the flare due to the difference between the size of the colorimetric patch and the size of the evaluation patch even when a chart with the colorimetric patch and the evaluation patch of different sizes is used.

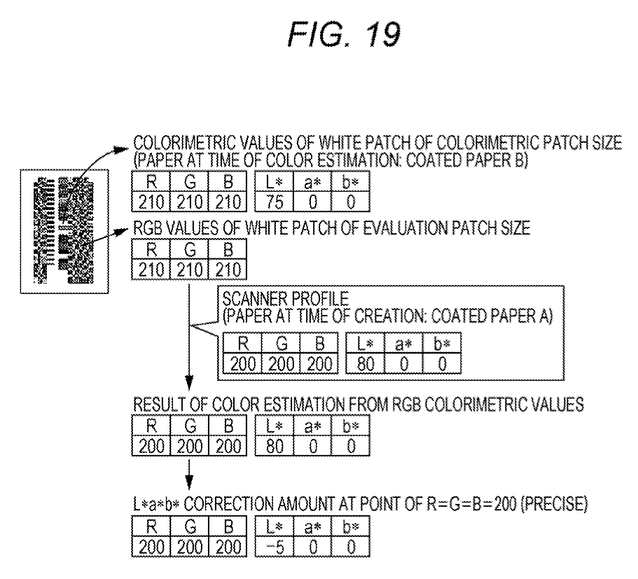

FIG. 19 illustrates the hybrid correction when the colorimetric patch and the evaluation patch have different sizes. In the case of performing color verification using the chart having the configuration illustrated in FIG. 16, since the estimated L*a*b* values worked out from the RGB values of the evaluation patch is used in the color verification, the L*a*b* correction amount is more precise in a case where the evaluation patch is also used when the RGB values used in the hybrid correction are acquired (FIG. 19 uses a white evaluation patch same as the colorimetric patch), for the reason that the influence of the flare is the same.

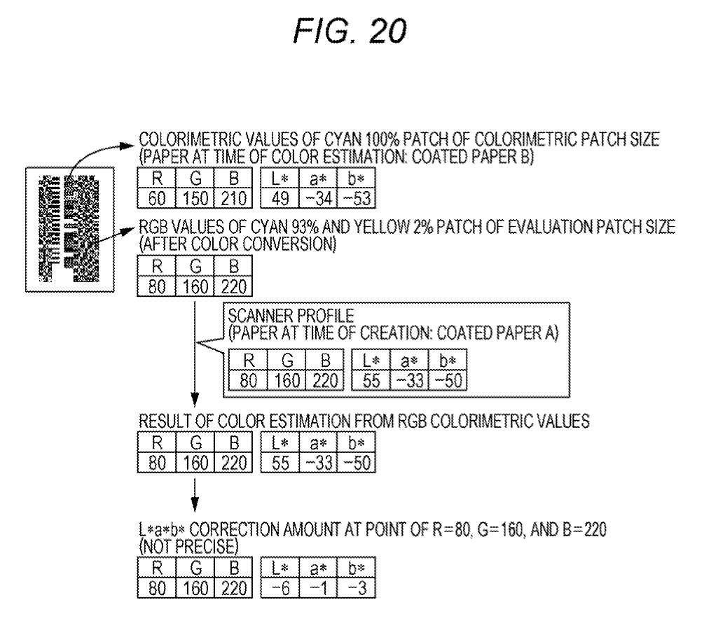

However, when the evaluation patches on which color conversion (color management) has been performed are printed, as illustrated in FIG. 20, an evaluation patch with the same CMYK values as those of the colorimetric patch (cyan 100% in the FIG. 20) is not always present therein (the evaluation patch after the color conversion has cyan 93% and yellow 2%). If the RGB values of the patches do not match between the estimated L*a*b* values worked out from the RGB values of the evaluation patch and colorimetric L*a*b* values of the colorimetric patch, the L*a*b* correction amount worked out from the estimated L*a*b* values and the colorimetric L*a*b* values is no longer precise and it is difficult to perform highly accurate correction.

Therefore, in one embodiment of the present invention, a chart is created in which patches having the same CMYK values as those of the colorimetric patches (large size) are arranged with an evaluation patch size (small size) and the hybrid correction is performed using this chart. Specifically, when, using a printing system including: a printer that prints a chart; a scanner that measures the chart to acquire an RGB value; and a colorimeter that measures the chart to acquire a color value (here, the L*a*b* value), a color value is estimated using the RGB value obtained by measuring the chart and a scanner profile stored in advance, and a correction amount of the color value is calculated based on the color value obtained by measuring the chart and the estimated color value, a first patch group (evaluation patches) of a first size for acquiring an RGB value used for color evaluation and a second patch group (colorimetric patches) of a second size larger than the first size for acquiring the color value are provided, a chart including a specific patch with the same CYMK value as a CYMK value of each patch of the second patch group is created in the first patch group, the color value is estimated using an RGB value obtained by measuring the specific patch in the first patch group and the scanner profile, and the correction amount of the color value is calculated based on a color value obtained by measuring each patch of the second patch group and the estimated color value.

With the chart having such a configuration, it is possible to calculate a proper L*a*b* correction amount in consideration of the influence of the flare even for different patch sizes. In addition, since it is sufficient to include a patch with the same CMYK values as those of the colorimetric patch in the evaluation patches, it is possible to calculate a proper L*a*b* correction amount with the minimum number of patches.

### Embodiments

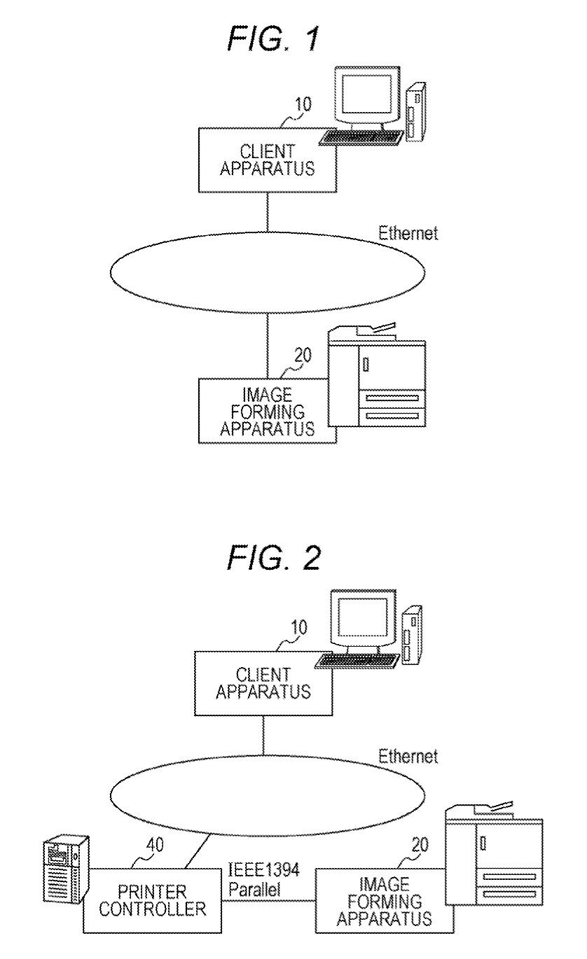

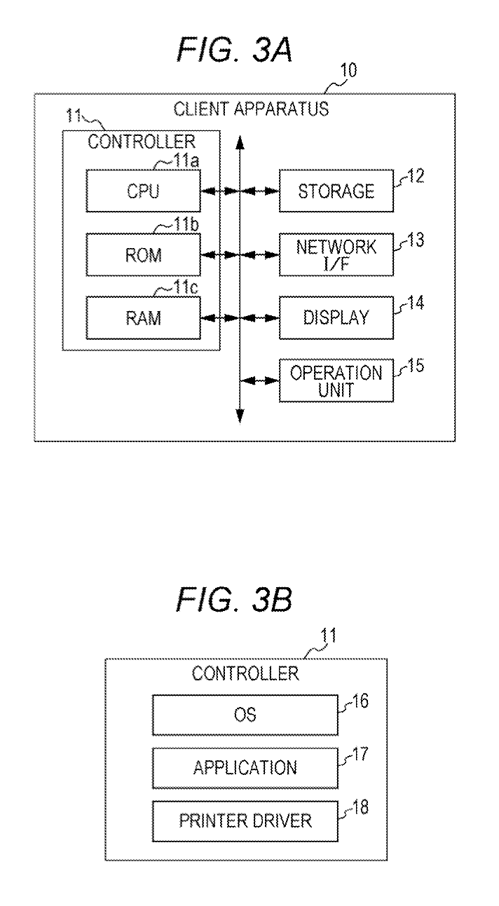

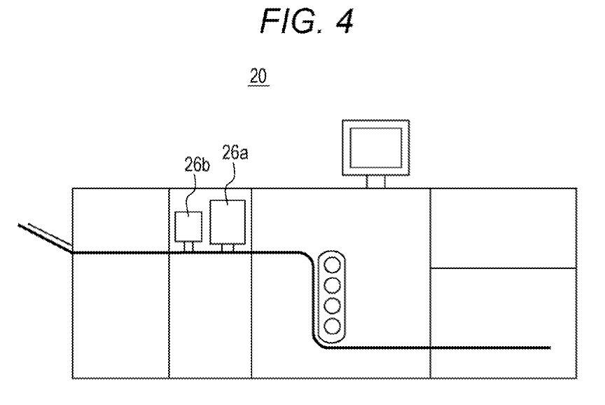

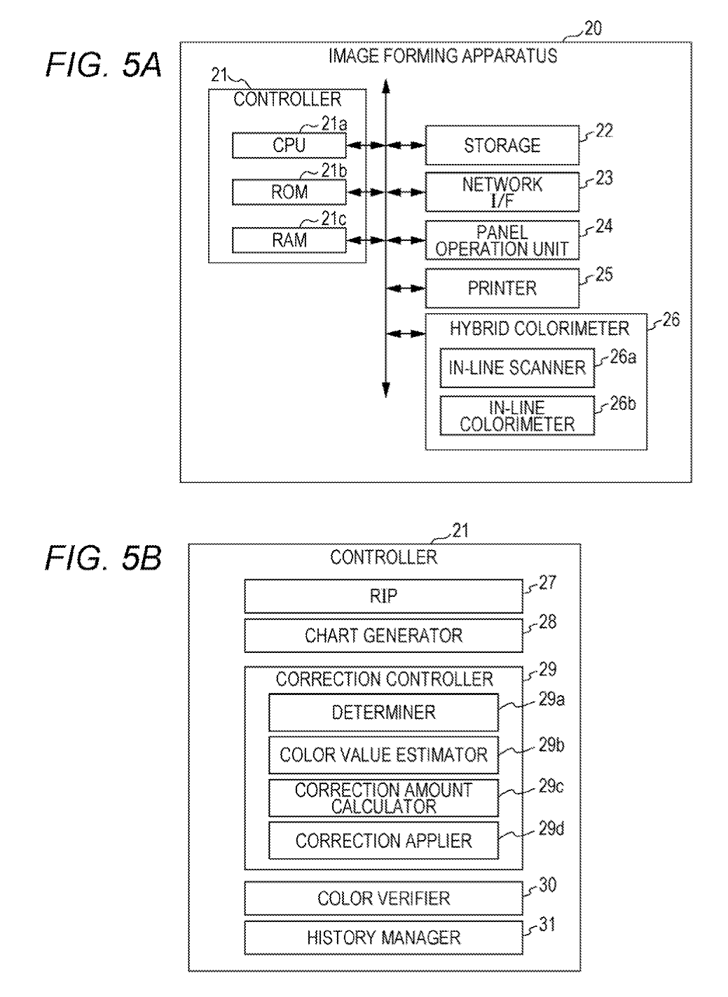

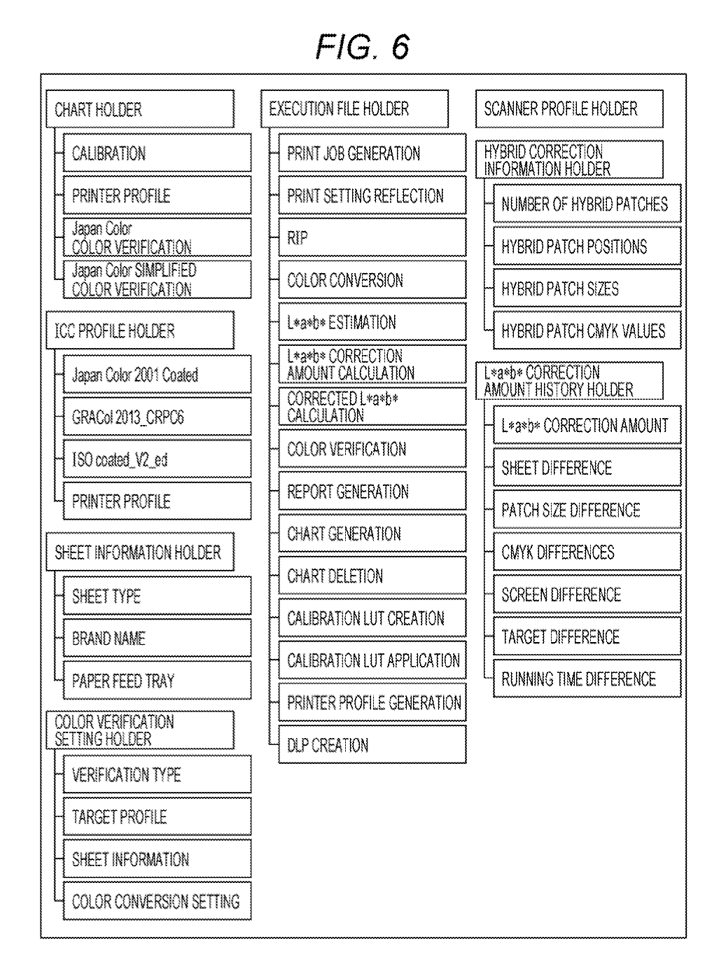

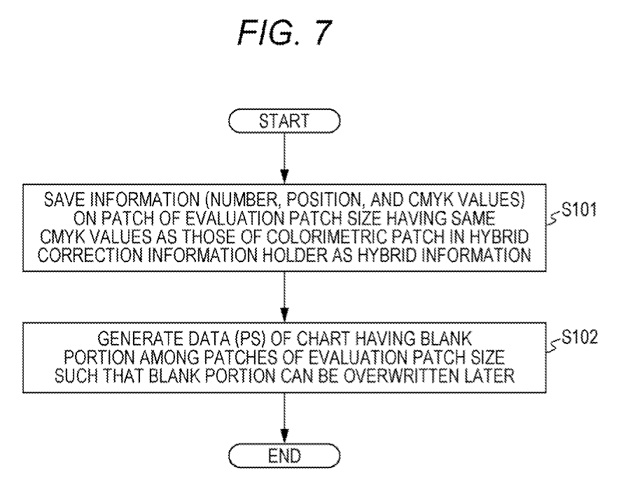

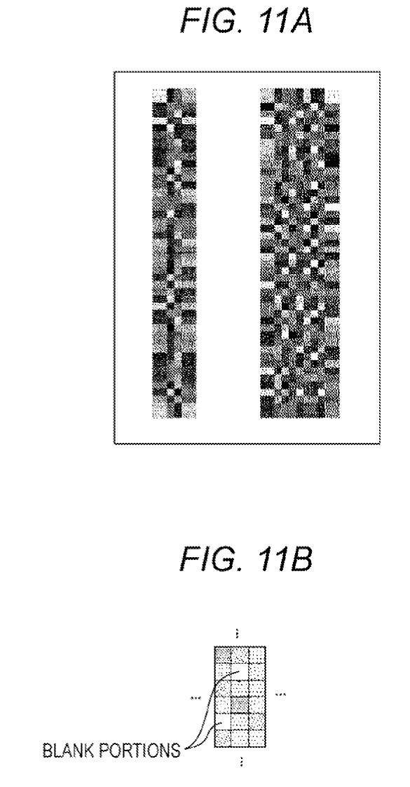

In order to explain the above-described embodiment of the present invention in further detail, a color value correction control method, a color value correction control program, and an image forming apparatus according to an embodiment of the present invention will be described with reference to FIGS. 1 to 11B. FIGS. 1 and 2 are schematic diagrams illustrating configurations of a printing system according to the present embodiment and FIGS. 3A and 3B are block diagrams illustrating a configuration of a client apparatus. FIG. 4 is an external view of an image forming apparatus according to the present embodiment, FIGS. 5A and 5B are block diagrams illustrating a configuration of the image forming apparatus, and FIG. 6 is a block diagram illustrating data stored in a storage of the image forming apparatus. In addition, FIGS. 7 to 10 are flowchart diagrams illustrating the actions of the image forming apparatus and FIGS. 11A and 11B are examples of a color verification chart according to the present embodiment.

As illustrated in FIG. 1, in the printing system of the present embodiment, a client apparatus 10 and an image forming apparatus 20 that can be connected through a communication network are arranged individually on an intranet. Note that, in FIG. 1, the printing system is configured by the client apparatus 10 and the image forming apparatus 20, but a printer controller 40 that controls the image forming apparatus 20 may be provided separately from the image forming apparatus 20. Ethernet (registered trademark) or the like can be used as the standard of the aforementioned communication network, but in addition to Ethernet (registered trademark), IEEE 1394, Parallel, and the like can be used for data transfer from the printer controller 40 to the image forming apparatus 20. In addition, FIGS. 1 and 2 illustrate a configuration in which the image forming apparatus 20 is provided with an in-line scanner and an in-line colorimeter, but a configuration using an external colorimeter or an external scanner may be employed. Each apparatus will be described in detail below.

[Client Apparatus]

The client apparatus 10 is a computer apparatus such as a personal computer and, as illustrated in FIG. 3A, configured by a controller 11, a storage 12, a network I/F 13, a display 14, an operation unit 15, and the like.

The controller 11 is configured by a central processing unit (CPU) 11a and memories such as a read only memory (ROM) 11b and a random access memory (RAM) 11c and these members are connected via a bus. The CPU 11a performs overall control of the client apparatus 10 by reading a program from the ROM 11b or the storage 12, loading the program in the RAM 11c, and executing the program.

As illustrated in FIG. 3B, the above-described controller 11 also functions as an operating system (OS) 16 such as Windows (registered trademark) or Mac OS (registered trademark), an application 17 that creates a document on the OS 16, a printer driver 18 that converts data of the document created by the application 17 into language that can be interpreted by the image forming apparatus 20 (page description language (PDL) such as printer control language (PCL) or post script (PS)) and also designates printing conditions and post-processing conditions to generate a print job, and the like.

The storage 12 is configured by a hard disk drive (HDD), a solid state drive (SSD), or the like and retains a program, document data, a print job, and the like for the CPU 11a to control each member.

The network I/F 13 is configured by a network interface card (NIC), a modem, or the like to establish a connection with the image forming apparatus 20 linked via the communication network and transmit a print job and the like.

The display 14 is configured by a liquid crystal display (LCD) or the like and displays a screen for creating a document, a screen for setting printing conditions and post-processing conditions for a document, and the like. The operation unit 15 is configured by a keyboard, a mouse, a touch panel integrated with the display 14, or the like and enables operations such as document creation, setting of printing conditions and post-processing conditions, and the like.

[Image Forming Apparatus]

The image forming apparatus 20 is multi-functional peripherals (MFP) or the like that execute a print process in accordance with a print job and, in the present embodiment, in order to ensure that the hybrid correction can be simply performed, an in-line scanner 26a and an in-line colorimeter 26b are arranged on a conveyance path through which a chart for which printing is completed is conveyed to a paper discharge tray, as illustrated in FIG. 4. As illustrated in FIGS. 5A and 5B, this image forming apparatus 20 is configured by a controller 21, a storage 22, a network I/F 23, a panel operation unit 24, a printer 25, a hybrid colorimeter 26, and the like.

The controller 21 is configured by a CPU 21a and memories such as a ROM 21b and a RAM 21c and these members are connected via a bus. The CPU 21a performs overall control of the image forming apparatus 20 by reading a program from the ROM 21b, loading the program in the RAM 21c, and executing the program. In addition, the controller 21 also functions as a raster image processor (RIP) 27, a chart generator 28, a correction controller 29, a color verifier 30, a history manager 31, and the like.

The RIP 27 translates a print job received from the client apparatus 10 and, if necessary, data of a color chart generated by the chart generator 28 to generate intermediate data, uses a color conversion table to perform color conversion on the intermediate data, and performs rendering to generate image data (this series of processes is referred to as rasterization process). The RIP 27 also performs a screen process, gradation correction, density balance adjustment, thinning, a halftone process, and the like on the image data as necessary.

The chart generator 28 generates data of color charts (the position, the size, CMYK values, and the like of each patch) for various uses such as color evaluation, color verification, and profile creation and saves the generated data in the storage 22 or the like. In particular, the present embodiment generates data of a color chart in which a first patch group (a plurality of evaluation patches) of a first size (a patch size measurable by the in-line scanner 26a) for acquiring the RGB values used for color evaluation and a second patch group (a plurality of colorimetric patches) of a second size larger than the first size (a patch size colorimetrically measurable by the in-line colorimeter 26b), with which the color values can be acquired, are arranged. At that time, the colorimetric patches are configured so as to include patches having CMYK values mostly forming color gamut shell colors, whereas the evaluation patches are designed to include a patch (referred to as specific patch) having the same CYMK values as those of each colorimetric patch. Note that the CMYK values of the colorimetric patch and/or the number of the colorimetric patches may be varied depending on a printing medium. In addition, the array of the specific patches with the same CYMK values as those of the colorimetric patches may be made the same as the array of the colorimetric patches, while the evaluation patches including the specific patches may be arrayed based on the technique mentioned in the prior application such that the flare influence amount is constant.

The correction controller 29 performs control for correcting the color value in consideration of the influence of the flare. This correction controller 29 is provided with a determiner 29a, a color value estimator 29b, a correction amount calculator 29c, a correction applier 29d, and the like.

The determiner 29a compares the RGB values obtained by the scanner (the in-line scanner 26a in this example) measuring the colorimetric patch and the RGB values obtained by the scanner measuring the evaluation patch (specific patch) with the same CMYK values as those of the colorimetric patch and determines whether the difference between the RGB values exceeds a threshold value specified in advance. Here, variations in the RGB values include both of variations caused by an engine (the printing color of the patch) and variations caused by the flare, where the variations caused by the engine greatly vary depending on the colors of the patches and the variations caused by the flare vary a little depending on the colors of the patches. Therefore, the determiner 29a may determine whether the difference between the RGB values exceeds the threshold value (first threshold value) specified in advance and also determine whether the variation in the difference between the RGB values (for example, standard deviation) exceeds a threshold value (second threshold value) specified in advance.

When the difference between the RGB values exceeds the threshold value, the color value estimator 29b calculates the L*a*b* values in accordance with the correction control of the present embodiment, using the RGB values obtained by the scanner (in-line scanner 26a) measuring the specific patch with the same CYMK values as those of the colorimetric patch among the evaluation patches and the scanner profile stored in the storage 22 in advance. Meanwhile, when the difference between the RGB values is equal to or less than the threshold value, the L*a*b* values are calculated in accordance with the normal hybrid correction, using the RGB values obtained by the scanner (in-line scanner 26a) measuring the colorimetric patch and the scanner profile. The L*a*b* values thus calculated is referred to as the estimated L*a*b* values. Note that, in a case where the determiner 29a determines whether the difference between the RGB values exceeds the threshold value and also determines whether the variation in the difference between the RGB values exceeds the threshold value, when the difference between the RGB values is equal to or less than the threshold value and the variation in the difference between the RGB values exceeds the threshold value, it is deemed that the variation caused by the engine is dominant (there is not much influence of the flare) and accordingly, the estimated L*a*b* values may be calculated in accordance with the normal hybrid correction, using the RGB values obtained by measuring the colorimetric patch and the scanner profile. In addition, when the difference between the RGB values is equal to or less than the threshold value and the variation in the difference between the RGB values is equal to or less than the threshold value, it is deemed that there is not much influence of the engine or influence of the flare and there is no problem in calculating the estimated L*a*b* values in accordance with any of the correction control of the present embodiment and the normal hybrid correction. In this case, however, it is assumed that the estimated L*a*b* values are calculated in accordance with the correction control of the present embodiment, using the RGB values obtained by measuring the specific patch with the same CYMK values as those of the colorimetric patch and the scanner profile.

The correction amount calculator 29c calculates the L*a*b* correction amount based on the estimated L*a*b* values calculated by the color value estimator 29b and the L*a*b* values (colorimetric L*a*b* values) obtained by the colorimeter (in-line colorimeter 26b) colorimetrically measuring the colorimetric patch.

The correction applier 29d uses the L*a*b* correction amount calculated by the correction amount calculator 29c to correct the estimated L*a*b* values that have been estimated using the RGB values obtained by measuring each evaluation patch excluding the specific patch and the scanner profile and acquires the estimated L*a*b* values that have been corrected (corrected L*a*b* values).

The color verifier 30 uses the corrected L*a*b* values of the evaluation patch on the color verification chart to compute a color difference from a target color value, or the like in accordance with a color verification setting. Specifically, the corrected L*a*b* values of the evaluation patch is compared with the L*a*b* values specified by the color certification standard and it is determined whether the color verification criteria are satisfied depending on whether the hue difference ΔH and the color difference ΔE are within predetermined ranges. Then, a report indicating the result of the color verification is generated and, for example, displayed on the panel operation unit 24 or output and printed by the printer 25.

Once the L*a*b* correction amount is calculated by the correction amount calculator 29c, the history manager 31 correlates this L*a*b* correction amount with various items of information (a sheet, a screen, the evaluation patch size, the difference in the CMYK values between the colorimetric patch and the evaluation patch, a target, and a running time period) to save in the storage 22 or the like. At that time, if the L*a*b* correction amount is equal to or less than a threshold value specified in advance, a chart for calculating the L*a*b* correction amount is no longer necessary such that the data of the unnecessary chart is deleted from the storage 22 or the like.

Note that the RIP 27, the chart generator 28, the correction controller 29, the color verifier 30, and the history manager 31 described above may be configured as hardware or may be configured as the color value correction control program that causes the controller 21 to function as the RIP 27, the chart generator 28, the correction controller 29, the color verifier 30, and the history manager 31 (in particular, the chart generator 28 and the correction controller 29) such that this color value correction control program is executed by the CPU 21a. In addition, in a case where the correction control of the present embodiment is executed irrespective of the values of the RGB values obtained by measuring the specific patch (the normal hybrid correction is not performed), the process of the determiner 29a may be omitted.

The storage 22 is configured by an HDD, an SSD, or the like and retains various programs and data for the CPU 21a to control each member. FIG. 6 is an example of data retained in the storage 22.

A scanner profile holder holds a correspondence table (scanner profile) that associates the RGB values with the color values such as the L*a*b* values or XYZ values for each K plate amount. Note that this scanner profile may be created by the image forming apparatus 20 or a scanner profile created by an image forming apparatus of a different lot may be downloaded.

A hybrid correction information holder stores the number of patches, the patch positions, the patch sizes, the CYMK values, and the like of the colorimetric patches for each chart.

An L*a*b* correction amount history holder stores history information for the history manager 31 to determine the necessity of using the chart including the colorimetric patches. Specifically, the L*a*b* correction amount, a sheet difference, a patch size difference, CMYK differences, a screen difference, a target difference, a running time difference, and the like are stored.

An execution file holder stores programs (including the color value correction control program) that perform print job generation, reflection of print settings, RIP, color conversion, estimation of the L*a*b* values, calculation of the L*a*b* correction amount, calculation of the corrected L*a*b* values, color verification, report generation, chart generation, chart deletion, calibration lookup table (LUT) creation, calibration LUT application, printer profile generation, device link profile (DLP) creation, and the like. Note that, in the calibration LUT generation, the estimated L*a*b* values of the evaluation patch on a calibration chart is used to create an LUT that associates CMYK with C′M′Y′K′ to correct input and output curves of the image forming apparatus to be ideal curves. In addition, in the printer profile generation, the estimated L*a*b* values of the evaluation patch on a printer profile generation chart is used to create an international color consortium (ICC) profile indicating a relationship as to what color values are given when the CMYK values in the image forming apparatus 20 are output. In the device link profile (DLP) generation, a DLP that associates CMYK with C′M′Y′K′, in which information necessary for reproducing a target color in the image forming apparatus 20 is stated, is created from the information in the printer profile and a target profile.

A chart holder stores data of various charts (the position, the size, CMYK values, and the like of each patch). Specifically, data of the calibration chart, the printer profile generation chart, a Japan Color color verification chart, a Japan Color simplified color verification chart, and the like is stored.

An ICC profile holder stores various profiles. Specifically, Japan Color 2001 Coated, GRACol 2013_CRPC6, ISO coated_V2_ed, the printer profile, and the like are stored.

A sheet information holder stores information relating to each sheet (a sheet type, a brand name, a paper feed tray, and the like).

A color verification setting holder stores setting information on color verification (a verification type, a target profile, sheet information, a color conversion setting) and the like.

Returning to FIG. 5A, the network I/F 23 is configured by an NIC, a modem, or the like to establish a connection with the client apparatus 10 linked via a network and receives a print job and the like from the client apparatus 10.

The panel operation unit 24 is a touch panel in which a touch sensor constituted by a lattice-like transparent electrode is formed on a display such as an LCD and displays various screens such as a screen indicating the result of color verification to enable various operations on these screens.

The printer 25 is an engine that executes a print process based on image data. Specifically, the printer 25 is provided with an exposure member that causes exposure by radiating a laser beam based on image data, a photoconductive drum, a developing apparatus, a charging apparatus, a photoconductor cleaner, and a primary transfer roller and is configured by an image former that forms toner images of respective colors of CMYK, an intermediate belt functioning as an intermediate transfer body, which is rotated by a roller to convey the toner images formed by the image former to a sheet, a secondary transfer roller that transfers the toner images formed on the intermediate belt to the sheet, a fixer that fixes the toner images transferred onto the sheet, a conveyer that conveys the sheet, such as a paper feed roller, a registration roller, a loop roller, a reversing roller, and a paper discharge roller, and the like.

The hybrid colorimeter 26 is configured by the in-line scanner 26a and the in-line colorimeter 26b provided, for example, on a conveyance path for the sheet between the fixer and the paper discharge tray described above. The in-line scanner 26a is configured, for example, by three types of sensors of RGB and measures reflected light from each patch on a chart formed on the sheet by the printer 25 to output the RGB values. In addition, the in-line colorimeter 26b is a spectrocolorimeter of a spectrum scheme capable of gauging each wavelength of light and measures an absorption spectrum of each patch on the chart formed on the sheet by the printer 25 to output colorimetric values (e.g., the L*a*b* values and the XYZ values; the present embodiment employs the L*a*b* values).

Note that FIGS. 1 to 6 are examples of the printing system of the present embodiment and the configuration and control of each apparatus can be appropriately modified.

For example, in the case of a configuration in which the printer controller 40 is arranged separately from the image forming apparatus 20 as illustrated in FIG. 2, a controller of the printer controller 40 may be equipped with functions of the RIP 27, the chart generator 28, the correction controller 29, the color verifier 30 and the history manager 31 (in particular, the chart generator 28 and the correction controller 29) (alternatively, a CPU constituting the controller of the printer controller 40 may be caused to execute the color value correction control program).

Hereinafter, the action of the printing system of the present embodiment will be described with reference to FIGS. 7 to 11B. The CPU 21a loads the color value correction control program stored in the ROM 21b or the storage 22 in the RAM 21c to execute, thereby executing the process of each step illustrated in the flowcharts in FIGS. 7 to 11B.

First, with reference to the flowchart diagram in FIG. 7, a description will be given of a procedure of generating data of a chart that enables to arrange the specific patch having the same CMYK values as those of the colorimetric patch among the evaluation patches.

[Chart Generation]

As illustrated in FIG. 7, the controller 21 (chart generator 28) saves information (the number, the position, and CMYK values) on the patch of the evaluation patch size having the same CMYK values as those of the colorimetric patch in the hybrid correction information holder as hybrid information (S101). Note that the colorimetric patches preferably include at least a patch having CMYK values locating at a color gamut outermost shell and, by setting such that the CMYK values of the colorimetric patches include the CMYK values locating at the color gamut outermost shell, the L*a*b* correction amount can be worked out with the minimum patches.

Next, the controller 21 (chart generator 28) generates data (for example, post script data) of a chart having a blank portion among the evaluation patches of the evaluation patch size such that blank portion can be overwritten later and saves the data in the chart holder (S102). FIGS. 11A and 11B are examples of images of the color verification chart created by this process. As illustrated in FIG. 11A, the evaluation patches of respective colors (in the drawings, colors are represented by shading of hatching) are arranged on both sides of the center of the sheet (an area to be colorimetrically measured by the in-line colorimeter 26b). FIG. 11B is a schematic diagram enlarging a part of FIG. 11A, in which a blank portion for being overwritten by the evaluation patch (specific patch) with the same CMYK values as those of the colorimetric patch is provided among the evaluation patches.

Note that, when a patch having CMYK values sufficiently close to those of the colorimetric patch is included in the evaluation patches, a blank portion for being overwritten by the evaluation patch with the same CMYK values as those of the colorimetric patch may not be provided. In addition, in this example, since the evaluation patch after color management is arranged in the color verification chart, a blank portion for being overwritten by the evaluation patch with the same CMYK values as those of the colorimetric patch is provided among the evaluation patches. However, the patch having CMYK values after color management may be arranged as the colorimetric patch and, in that case, it is not necessary to provide a blank portion among the evaluation patches.

Furthermore, the CMYK values of the colorimetric patch and the number of the colorimetric patches may be changed depending on the printing medium and, by coping with the difference due to the printing medium, the colorimetric accuracy can be further improved with the optimum CMYK values and number of the patches. In addition, the evaluation patch having the identical CMYK values as those of the colorimetric patch may be put in the same patch order as that of the colorimetric patch. Additionally, in order to make the influence of the flare constant, the evaluation patches may be arranged using the technique disclosed in JP 2016-159540 A. In that case, since the influence of the flare can be equalized to that of surrounding patches, it is possible to further improve the colorimetric accuracy.

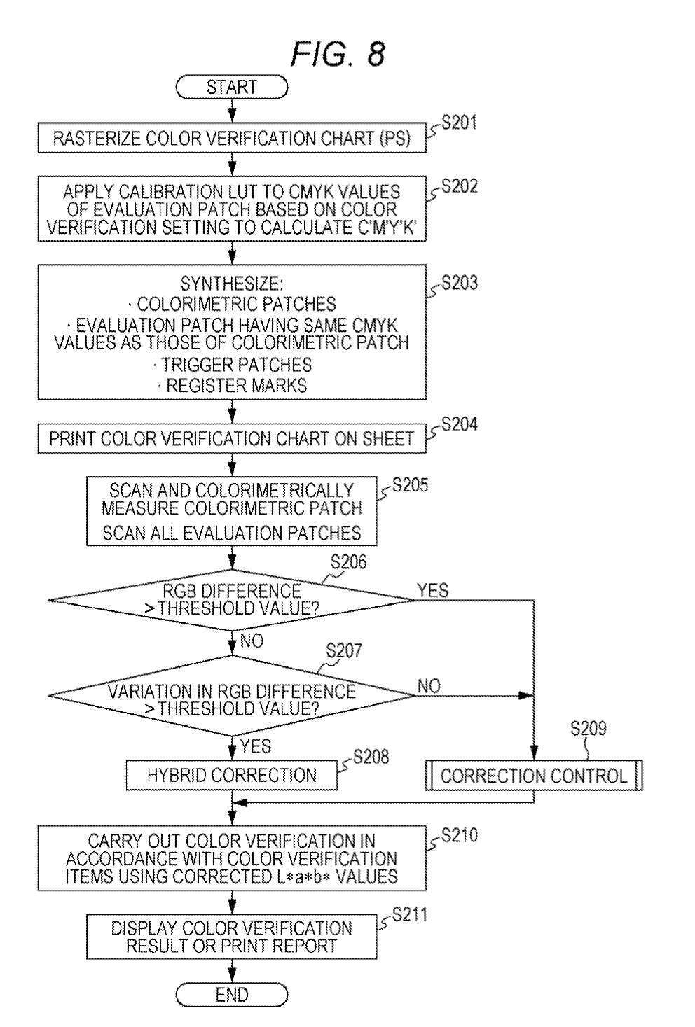

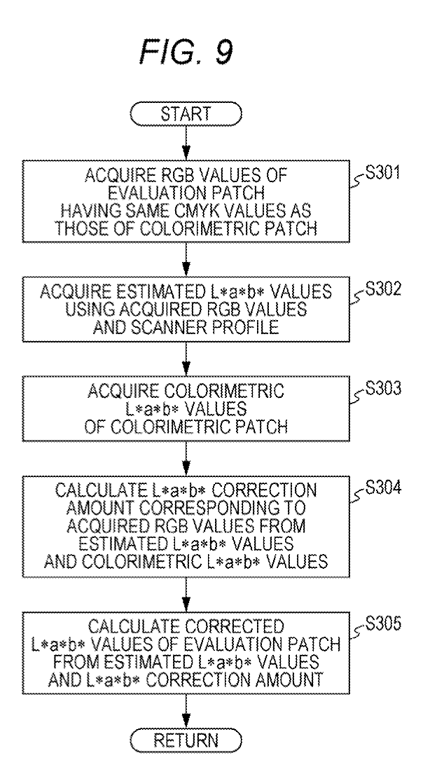

Next, a procedure of performing color verification using the data of the chart generated in the above flow will be described with reference to the flowchart diagrams in FIGS. 8 and 9.

[Color Verification]

As illustrated in FIG. 8, the controller 21 (RIP 27) reads the data of the color verification chart saved in the chart holder in the above flow (data of the evaluation patches stated by post script or the like) to rasterize (S201).

Next, the controller 21 (chart generator 28) applies a calibration LUT to the CMYK values of the evaluation patch based on a color verification setting stored in the color verification setting holder and calculates the CMYK values (C′M′Y′K′ values) after color conversion (color management) (S202).

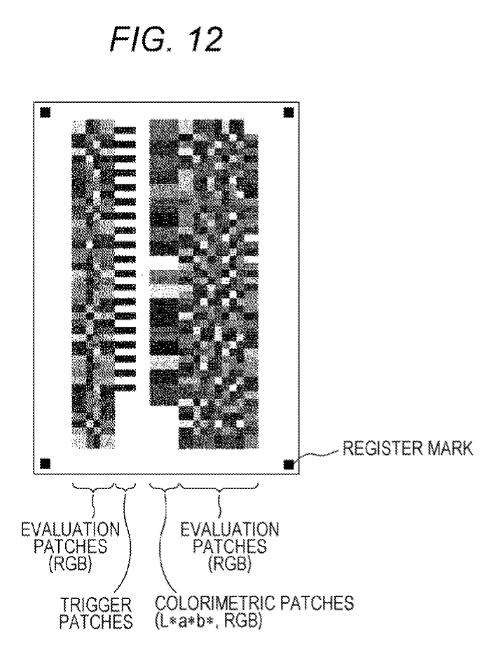

Next, the controller 21 (chart generator 28) synthesizes the images of the colorimetric patches, the evaluation patch having the same CMYK values as those of the colorimetric patch, the trigger patches, and the register marks on the image of the color verification chart (S203). The printer 25 prints the color verification chart on a sheet (S204). FIG. 12 is an example of the color verification chart printed on the sheet, in which the colorimetric patches are arranged between the evaluation patches on both sides of the sheet (substantially at the center in a direction orthogonal to the paper passing direction of the sheet) and the evaluation patches having the same CMYK values as those of the colorimetric patches are arranged in the blank portions in FIG. 11B. Furthermore, the trigger patches with the same pitch as that of the colorimetric patches are arranged in the vicinity of the colorimetric patches and the register marks are arranged at the four corners of the sheet.

Next, the hybrid colorimeter 26 (in-line scanner 26a) scans the colorimetric patch and all the evaluation patches on the color verification chart to acquire the RGB values and the hybrid colorimeter 26 (in-line colorimeter 26b) colorimetrically measures the colorimetric patch and acquires the color values (L*a*b* values in this example) (S205).

Next, as necessary, the controller 21 (the determiner 29a of the correction controller 29) analyzes the RGB values obtained by scanning by the in-line scanner 26a and ascertains whether a difference between the RGB values of the colorimetric patch and the RGB values of the evaluation patch with the same CMYK values as those of the colorimetric patch exceeds the threshold value specified in advance (S206). When the difference between the RGB values is equal to or less than the threshold value (No in S206), the controller 21 ascertains whether the variation in the difference between the RGB values (for example, standard deviation) exceeds the threshold value specified in advance (S207).

Here, as described earlier, variations in the RGB values include both of the variations caused by the engine and the variations caused by the flare, where the variations caused by the engine greatly vary depending on the colors of the patches and the variations caused by the flare vary a little depending on the colors of the patches. Therefore, when the difference between the RGB values is equal to or less than the threshold value (No in S206) and the variation in the difference between the RGB values exceeds the threshold value (Yes in S207), it is deemed that the variation caused by the engine is dominant (there is not much influence of the flare) and accordingly, the controller 21 (correction controller 29) performs the normal hybrid correction (S208). Specifically, the RGB values of the colorimetric patch are acquired such that the estimated L*a*b* values are acquired using the acquired RGB values and the scanner profile and the L*a*b* correction amount is calculated from the estimated L*a*b* values and the colorimetric L*a*b* values of the colorimetric patch. Then, the corrected L*a*b* values are calculated from the estimated L*a*b* values and the L*a*b* correction amount of each evaluation patch.

On the other hand, when the difference between the RGB values exceeds the threshold value (Yes in S206), it is deemed that the variation caused by the flare is dominant and accordingly, the controller 21 (correction controller 29) performs the correction control of the present embodiment (S209). In addition, when the difference between the RGB values is equal to or less than the threshold value (No in S206) and the variation in the difference between the RGB values is equal to or less than the threshold value (No in S207), it is deemed that there is not much influence of the engine or influence of the flare and there is no problem in calculating the corrected L*a*b* values in accordance with any of the correction control of the present embodiment and the normal hybrid correction. In this example, however, the controller 21 (correction controller 29) performs the correction control of the present embodiment (S209). FIG. 9 illustrates details of the correction control. First, the controller 21 (color value estimator 29b) acquires the RGB values of the evaluation patch having the same CMYK values as those of the colorimetric patch (S301) and acquires the estimated L*a*b* values using the acquired RGB values and the scanner profile (S302). Next, the controller 21 (correction amount calculator 29c) acquires the colorimetric L*a*b* values of the colorimetric patch (S303) and calculates the L*a*b* correction amount corresponding to the RGB values acquired in S301 from the estimated L*a*b* values and the colorimetric L*a*b* values (S304). Then, the controller 21 (correction applier 29d) calculates the corrected L*a*b* values from the estimated L*a*b* values and the L*a*b* correction amount of each evaluation patch (S305).

Returning to FIG. 8, the controller 21 (color verifier 30) carries out color verification in accordance with color verification items using the corrected L*a*b* values (S210) and displays the color verification result on the panel operation unit 24 or causes the printer 25 to print a report (S211).

Note that, in the above description, it is ascertained whether the difference between the RGB values of the colorimetric patch and the RGB values of the evaluation patch with the same CMYK values as those of the colorimetric patch exceeds the threshold value specified in advance and whether the variation in the difference between the RGB values exceeds the threshold value specified in advance. However, S207 may be omitted such that the normal hybrid correction is performed when the difference between the RGB values is equal to or less than the threshold value and the correction control of the present embodiment is performed when the difference in RGB values exceeds the threshold value. Alternatively, S206 and S207 may be omitted such that the correction control of the present embodiment is always performed.

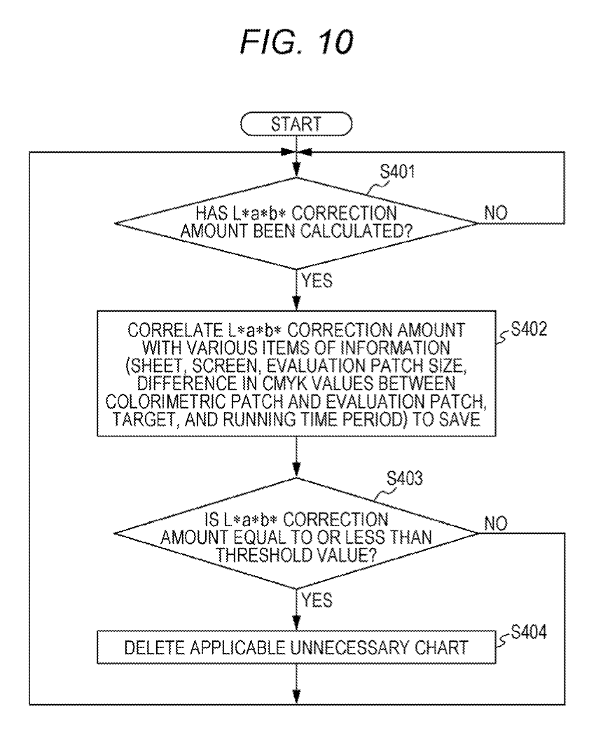

Next, a procedure of managing the L*a*b* correction amount calculated in the above flow will be described with reference to the flowchart diagram in FIG. 10.

[History Management]

As illustrated in FIG. 10, the controller 21 (history manager 31) ascertains whether the L*a*b* correction amount has been calculated by the correction controller 29 (S401) and, when the L*a*b* correction amount has been calculated (Yes in S401), correlates the L*a*b* correction amount with various items of information (the sheet, the screen, the evaluation patch size, the difference in the CMYK values between the colorimetric patch and the evaluation patch, the target, and the running time period) to save in the L*a*b* correction amount history holder of the storage 22 (S402).

Next, the controller 21 (history manager 31) ascertains whether each L*a*b* correction amount saved in the L*a*b* correction amount history holder is equal to or less than a threshold value specified in advance (S403). When the L*a*b* correction amount is equal to or less than the threshold value (Yes in S403), since a chart for calculating that L*a*b* correction amount is no longer necessary, the controller 21 deletes data of that chart from the chart holder (S404).

Note that the present invention is not limited to the above-described embodiments and the configurations and control of the printing system and each apparatus can be appropriately modified without departing from the gist of the present invention.

For example, the above-described embodiment describes a case where the color verification is performed using the corrected L*a*b* values to which the L*a*b* correction amount is applied. However, the color value correction control method of the present invention can be similarly applied to any process performed using the L*a*b* correction amount.

In addition, the above-described embodiment exemplifies the case of acquiring the L*a*b* values as the color values. However, the color value correction control method of the present invention can be similarly applied also to the case of acquiring the XYZ values as the color values.

Furthermore, the above-described embodiment has a configuration in which the hybrid colorimeter 26 is installed on the conveyance path for the sheet between the fixer of the printer 25 and the paper discharge tray. However, the in-line scanner 26a and/or the in-line colorimeter 26b constituting the hybrid colorimeter 26 can be provided in the vicinity of the intermediate belt. In that case, each patch on the chart whose image is formed on the intermediate belt can be colorimetrically measured. In addition, instead of the in-line scanner 26a and/or the in-line colorimeter 26b, a scanner and/or a colorimeter provided outside the image forming apparatus 20 also can be used.

The present invention can be used in a color value correction control method, a color value correction control program, a recording medium recording the color value correction control program, and an image forming apparatus including a colorimeter that measures a color value, which calculate a correction amount for correcting a color value in consideration of a flare level.

Although embodiments of the present invention have been described and illustrated in detail, the disclosed embodiments are made for purposes of illustration and example only and not limitation. The scope of the present invention should be interpreted by terms of the appended claims.

What is claimed is:

1. A color value correction control method that uses a printing system including: a printer that prints a chart on a printing medium; a scanner that measures the chart to acquire an RGB value; and a colorimeter that measures the chart to acquire a color value made up of an L*a*b* value or an XYZ value, the method comprising:
generating data of the chart;
estimating a color value using the RGB value obtained by the scanner measuring the chart printed by the printer based on the data and a scanner profile stored in advance; and
calculating a correction amount of the color value based on the color value obtained by the colorimeter measuring the chart and the estimated color value, wherein
in the generating, a first patch group for acquiring an RGB value used for color evaluation made up of a plurality of patches of a first size and a second patch group made up of a plurality of patches of a second size larger than the first size are provided and data of a chart including a specific patch with the same CYMK value as a CYMK value of each patch of the second patch group in the first patch group is generated,
in the estimating, the color value is estimated using an RGB value obtained by measuring the specific patch in the first patch group and the scanner profile, and
in the calculating, the correction amount of the color value is calculated based on a color value obtained by measuring each patch of the second patch group and the estimated color value.

2. The color value correction control method according to claim 1, further comprising
firstly determining whether a difference between the RGB value obtained by measuring the specific patch in the first patch group and the RGB value obtained by measuring each patch of the second patch group corresponding to the specific patch exceeds a first threshold value specified in advance, wherein
in the estimating, when the difference between the RGB values is equal to or less than the first threshold value, the color value is estimated using the RGB value obtained by measuring each patch of the second patch group and the scanner profile.

3. The color value correction control method according to claim 2, further comprising
secondly determining whether a variation in the difference between the RGB value obtained by measuring the specific patch in the first patch group and the RGB value obtained by measuring each patch of the second patch group corresponding to the specific patch exceeds a second threshold value specified in advance, wherein
in the estimating, when the difference between the RGB values is equal to or less than the first threshold value and the variation in the difference between the RGB values exceeds the second threshold value, the color value is estimated using the RGB value obtained by measuring each patch of the second patch group and the scanner profile.

4. The color value correction control method according to claim 1, further comprising
correcting a color value estimated using the RGB value obtained by measuring each patch of the first patch group and the scanner profile based on the correction amount of the color value.

5. The color value correction control method according to claim 4, further comprising
performing color verification based on a hue difference and/or a color difference between a corrected color value and a color value specified by a predetermined color certification standard.

6. The color value correction control method according to claim 1, wherein
in the generating, after an image of each patch of the first patch group excluding the specific patch is generated, an image of each patch of the second patch group and an image of the specific patch are synthesized and data of the chart is generated.

7. The color value correction control method according to claim 6, wherein
in the generating, an image of each patch of the first patch group excluding the specific patch is generated based on a CMYK value after color management.

8. The color value correction control method according to claim 1, wherein
in the generating, CMYK values of patches arranged in the second patch group and/or the number of the patches is varied depending on the printing medium.

9. The color value correction control method according to claim 1, wherein
in the generating, an array of the specific patches in the first patch group is made the same as an array of the patches of the second patch group.

10. A non-transitory recording medium storing a computer readable color value correction control program that acts in an apparatus in a printing system including: a printer that prints a chart on a printing medium; a scanner that measures the chart to acquire an RGB value; and a colorimeter that measures the chart to acquire a color value made up of an L*a*b* value or an XYZ value, the program causing the apparatus to execute:
generating data of the chart;
estimating a color value using the RGB value obtained by the scanner measuring the chart printed by the printer based on the data and a scanner profile stored in advance; and
calculating a correction amount of the color value based on the color value obtained by the colorimeter measuring the chart and the estimated color value, wherein
in the generating, a first patch group for acquiring an RGB value used for color evaluation made up of a plurality of patches of a first size and a second patch group made up of a plurality of patches of a second size larger than the first size are provided and data of a chart including a specific patch with the same CYMK value as a CYMK value of each patch of the second patch group in the first patch group is generated,
in the estimating, the color value is estimated using an RGB value obtained by measuring the specific patch in the first patch group and the scanner profile, and
in the calculating, the correction amount of the color value is calculated based on a color value obtained by measuring each patch of the second patch group and the estimated color value.

11. The non-transitory recording medium storing a computer readable color value correction control program according to claim 10, the program causing the apparatus to further execute
firstly determining whether a difference between the RGB value obtained by measuring the specific patch in the first patch group and the RGB value obtained by measuring each patch of the second patch group corresponding to the specific patch exceeds a first threshold value specified in advance, wherein
in the estimating, when the difference between the RGB values is equal to or less than the first threshold value, the color value is estimated using the RGB value obtained by measuring each patch of the second patch group and the scanner profile.

12. The non-transitory recording medium storing a computer readable color value correction control program according to claim 11, the program causing the apparatus to further execute
secondly determining whether a variation in the difference between the RGB value obtained by measuring the specific patch in the first patch group and the RGB value obtained by measuring each patch of the second patch group corresponding to the specific patch exceeds a second threshold value specified in advance, wherein
in the estimating, when the difference between the RGB values is equal to or less than the first threshold value and the variation in the difference between the RGB values exceeds the second threshold value, the color value is estimated using the RGB value obtained by measuring each patch of the second patch group and the scanner profile.

13. The non-transitory recording medium storing a computer readable color value correction control program according to claim 10, the program causing the apparatus to further execute
correcting a color value estimated using the RGB value obtained by measuring each patch of the first patch group and the scanner profile based on the correction amount of the color value.

14. The non-transitory recording medium storing a computer readable color value correction control program according to claim 13, the program causing the apparatus to further execute
performing color verification based on a hue difference and/or a color difference between a corrected color value and a color value specified by a predetermined color certification standard.

15. The non-transitory recording medium storing a computer readable color value correction control program according to claim 10, wherein
in the generating, after an image of each patch of the first patch group excluding the specific patch is generated, an image of each patch of the second patch group and an image of the specific patch are synthesized and data of the chart is generated.

16. The non-transitory recording medium storing a computer readable color value correction control program according to claim 15, wherein
in the generating, an image of each patch of the first patch group excluding the specific patch is generated based on a CMYK value after color management.

17. The non-transitory recording medium storing a computer readable color value correction control program according to claim 10, wherein
in the generating, CMYK values of patches arranged in the second patch group and/or the number of the patches is varied depending on the printing medium.

18. The non-transitory recording medium storing a computer readable color value correction control program according to claim 10, wherein
in the generating, an array of the specific patches in the first patch group is made the same as an array of the patches of the second patch group.

19. An image forming apparatus including: a printer that prints a chart on a printing medium; a scanner that measures the chart to acquire an RGB value; and a colorimeter that measures the chart to acquire a color value made up of an L*a*b* value or an XYZ value, the image forming apparatus comprising
a hardware processor that:
generates data of the chart;
estimates a color value using the RGB value obtained by the scanner measuring the chart printed by the printer based on the data and a scanner profile stored in advance; and
calculates a correction amount of the color value based on the color value obtained by the colorimeter measuring the chart and the estimated color value, wherein
the hardware processor provides a first patch group for acquiring an RGB value used for color evaluation made up of a plurality of patches of a first size and a second patch group made up of a plurality of patches of a second size larger than the first size and generates data of a chart including a specific patch with the same CYMK value as a CYMK value of each patch of the second patch group in the first patch group,
the hardware processor estimates the color value using an RGB value obtained by measuring the specific patch in the first patch group and the scanner profile, and
the hardware processor calculates the correction amount of the color value based on a color value obtained by measuring each patch of the second patch group and the estimated color value.

20. The image forming apparatus according to claim 19, wherein
the hardware processor determines whether a difference between the RGB value obtained by measuring the specific patch in the first patch group and the RGB value obtained by measuring each patch of the second patch group corresponding to the specific patch exceeds a first threshold value specified in advance, and
when the difference between the RGB values is equal to or less than the first threshold value, the hardware processor estimates the color value using the RGB value obtained by measuring each patch of the second patch group and the scanner profile.

21. The image forming apparatus according to claim 20, wherein
the hardware processor further determines whether a variation in the difference between the RGB value obtained by measuring the specific patch in the first patch group and the RGB value obtained by measuring each patch of the second patch group corresponding to the specific patch exceeds a second threshold value specified in advance, and
when the difference between the RGB values is equal to or less than the first threshold value and the variation in the difference between the RGB values exceeds the second threshold value, the hardware processor estimates the color value using the RGB value obtained by measuring each patch of the second patch group and the scanner profile.

22. The image forming apparatus according to claim 19, wherein
the hardware processor corrects a color value estimated using the RGB value obtained by measuring each patch of the first patch group and the scanner profile based on the correction amount of the color value.

23. The image forming apparatus according to claim 22, wherein
the hardware processor performs color verification based on a hue difference and/or a color difference between a corrected color value and a color value specified by a predetermined color certification standard.

24. The image forming apparatus according to claim 19, wherein
after an image of each patch of the first patch group excluding the specific patch is generated, the hardware processor synthesizes an image of each patch of the second patch group and an image of the specific patch and generates data of the chart.

25. The image forming apparatus according to claim 24, wherein
the hardware processor generates an image of each patch of the first patch group excluding the specific patch based on a CMYK value after color management.

26. The image forming apparatus according to claim 19, wherein
the hardware processor varies CMYK values of patches arranged in the second patch group and/or the number of the patches depending on a classification of the printing medium.

27. The image forming apparatus according to claim 19, wherein
the hardware processor makes an array of the specific patches in the first patch group the same as an array of the patches of the second patch group.
